(19) United States
(12) Patent Application Publication
(10) Pub. No.: US 2023/0311326 A1
(43) Pub. Date: Oct. 5, 2023

(54) MONITORING DURING A ROBOT-ASSISTED PROCESS

(71) Applicant: KUKA Deutschland GmbH, Augsburg (DE)

(72) Inventor: Manuel Kaspar, Koenigsbrunn (DE)

(73) Assignee: KUKA Deutschland GmbH, Augsburg (DE)

(21) Appl. No.: 18/042,048

(22) PCT Filed: Aug. 12, 2021
(86) PCT No.: PCT/EP2021/072496

§ 371 Date: Feb. 17, 2023

(30) Foreign Application Priority Data
Aug. 19, 2020 (DE) 10 2020 210 530.8

(51) Int. Cl. B25J 9/16; G05B 23/02

(52) U.S. Cl. CPC B25J 9/1674; B25J 9/163; B25J 9/161; G05B 23/0254

(57) ABSTRACT

A method for monitoring during a robot-assisted first or second process-includes (a.1) detecting process data; and (a.2) performing a model-based assessment with the aid of a machine-learned model on the basis of the detected process data; wherein, if the model-based assessment satisfies an examination criterion, in particular depending on an external confirmation: (b.1) performing a test assessment with the aid of a testing authority; and (b.2) training the machine-learned model further on the basis of the test assessment; and then, for the first process optionally performed again: (c.1) detecting process data; (c.2) performing the model-based assessment with the aid of the further trained model on the basis of the detected process data; and (c.3) monitoring during the first process is performed on the basis of this assessment.

### CROSS-REFERENCE TO RELATED APPLICATIONS

This application is a national phase application under 35 U.S.C. § 371 of International Patent Application No. PCT/EP2021/072496, filed Aug. 12, 2021 (pending), which claims the benefit of priority to German Patent Application No. DE 10 2020 210 530.8, filed Aug. 19, 2020, the disclosures of which are incorporated by reference herein in their entirety.

### TECHNICAL FIELD

The present invention relates to a method for monitoring during a robot-assisted process, and to a system and a computer program product for performing the method.

### BACKGROUND

Robot-assisted processes, i.e., processes performed by means of one or more robots, are often highly automated. In particular, therefore, monitoring is particularly advantageous, but also particularly in the case of human-robot collaboration.

It is known from internal practice to use machine learning or a machine-learned model, wherein the monitoring is performed using the machine-learned model on the basis of detected process data.

Particularly advantageous applications are predictive maintenance of the robot(s) and monitoring for errors in the process and/or for errors of process products.

### SUMMARY

It is the object of the present invention to improve robot-assisted processes.

This object is achieved by a method, a system and computer program product for performing a method as described herein.

According to one embodiment of the present invention, for monitoring during a robot-assisted process, which is referred to herein as the first process without limiting the generality, for this first process or also another robot-assisted process, which in the present case is referred to as the second process without limiting the generality,
(a.1) process data are detected; and
(a.2) a model-based assessment is performed with the aid of a machine-learned model on the basis of these detected process data.

In one embodiment, for a plurality of cycles of this robot-assisted first or second process, in each case
(a.1) process data are detected; and, in one embodiment in the particular cycle, in another embodiment after a plurality of cycles,
(a.2) the model-based assessment (for the particular cycle) is performed with the aid of the machine-learned model on the basis of these detected process data (of the particular cycle).

As explained at the outset, the process is performed in one embodiment with the aid of one or more robots. In one embodiment, the robot or one or more robots comprises/comprise (in each case) a multi-axis, in one embodiment at least five-axis, in particular at least six-axis, in one embodiment at least seven-axis robot arm and/or a stationary or mobile base.

Additionally or alternatively, in one embodiment in each of the cycles of the robot or of one or more of the robots (in each case) runs/run the same program, in one embodiment (in each case) drives/drive the same path (s) and (in each case) performs/perform the same activities, which in particular can comprise a component transport and/or a component processing.

For such processes, in particular industry (industrial) processes, the present invention is particularly suitable due to the high degree of automation.

In one embodiment, the assessment comprises a two-stage or multi-stage classification, in particular a classification into (the classes) {“error-free” and “error/anomaly”} or {“error-free”, “first error/anomaly”, “second error/anomaly” and, if applicable, one or more further errors or anomalies}. Likewise, in one embodiment, the assessment may also comprise an anomaly score, an expected required maintenance or other.

According to an embodiment of the present invention, if the model-based assessment performed in step (a.2) satisfies an examination criterion, in one embodiment (additionally) depending on an external confirmation, in one embodiment only if both the assessment satisfies the examination criterion and the external confirmation is present or is positive:
(b.1) a test assessment is performed with the aid of a testing authority, in one embodiment on the basis of the process data detected in step (a.1), in another embodiment independently thereof, in a development on the basis of the process data used in step (a.2), in another development independently of process data used in step (a.2), in particular (instead) on the basis of other process data detected in step (a.1) or another part of the process data detected in step (a.1) or on the basis of data not detected in step (a.1), in one embodiment data detected instead in a separate test run or the like; and
(b.2) the machine-learned model is further trained on the basis of this test assessment and in one embodiment also the (associated) process data detected in step (a.1) and/or used in step (a.2).

In one development, for one or more of the above-mentioned cycles, in each case if the model-based assessment performed therein or in its step (a.2) satisfies an examination criterion, in one embodiment depending on an external confirmation, in one embodiment only if both the assessment satisfies the examination criterion and the external confirmation is present or is positive:

1(b.1) a test assessment is performed with the aid of a testing authority, in one embodiment on the basis of the process data detected in this cycle or in its step (a.1) or independently thereof, in a development on the basis of the process data used in this cycle or its step (a.2), in another development independently of process data used in step (a.2), in particular (instead) on the basis of other process data detected in step (a.1) or another part of the process data detected in step (a.1) or on the basis of data not detected in step (a.1), in one embodiment data detected instead in a separate test run or the like; and
(b.2) the model is further trained on the basis of this test assessment and in one embodiment also the process data detected in the (corresponding) cycle, in one embodiment used in its step (a.2).

According to an embodiment of the present invention, then, for this further training of the machine-learned model for the first process optionally performed again, (in one embodiment one or more further cycles of the first process in each case):
(c.1) process data are detected;
(c.2) the model-based assessment (for the particular cycle) is performed with the aid of the further trained model on the basis of these detected process data (of the particular cycle); and
(c.3) monitoring during the first process (S30; S81) is performed on the basis of this assessment.

One embodiment of the present invention is based on the following concept:

By way of the further training of the model on the basis of process data according to step (b.2), the performance of the model and thus the monitoring can be improved with the aid of the model in step (c.3). In this case, the use of process data of the first process which are detected in step (a.1) can improve the later monitoring in step (c.3), since the model is further trained in a process-specific manner. On the other hand, the use of process data of the second process which are detected in step (a.1) can advantageously allow (further) training without complete processing of the first process already for the purpose of the (further) training.

If, in step (b.2), the model is further trained on the basis of test assessments, in particular a so-called “labeling”, by a testing authority, for example a person who checks a functional state of the robot or manually assesses process products, this machine learning can be significantly improved. Accordingly, in one embodiment, the test assessment in step (b.1) comprises a labeling with the aid of the testing authority, in particular by the testing authority.

However, such a labeling is often complicated by a testing authority. Thus, the functional state check can require its own test run and/or disassembly of the robot, which impairs productivity. The manual assessment of process products is also correspondingly complicated.

Therefore, in one embodiment, the present invention proposes to selectively initiate such a test assessment only when it (likely particularly) is expedient, in particular necessary and/or particularly efficient or effective, which is decided by the examination criterion.

In this way, in one embodiment a labeling can be performed in a targeted manner only, in particular only for a part of the cycles. In one embodiment, on the one hand, the performance of the machine-learned model or the (assessment for) monitoring can be improved with the aid of the model and at the same time the effort for the labeling or further training can be reduced and thus productivity can be increased in one embodiment.

Since in one embodiment in step (b.1) the test assessment is performed with the aid of the testing authority on the basis of the process data used in step (a.2), in particular the effort for data detection and/or management, in particular storage, can be reduced.

Since, in another embodiment, in step (b.1) the test assessment is performed with the aid of the testing authority independently of the process data used in step (a.2), in particular on the basis of other process data detected in step (a.1) or another part of the process data detected in step (a.1) or else instead on the basis of other data detected in one embodiment during a separate test run or the like, in one embodiment the quality of the test assessment can be improved and/or a diversity can be used.

For example, a person as testing authority can use particularly advantageously image, video and/or audio data for the test assessment and kinematic and/or dynamic data of the one or more robots for the machine-learned model for model-based assessment, or in step (a.2) kinematic and/or dynamic robot data for the model-based assessment, and in step (b.1) a test assessment can be performed with the aid of a human testing authority on the basis of detected images, audio and/or video recordings or the like, independently of these robot data.

Likewise, an advantageous, in particular (more) precise test assessment can be performed on the basis of data detected during a separate test run, for example.

In one embodiment, the testing authority comprises one or more people. As a result, in one embodiment, in particular also particularly complex processes can be labeled in step (b.2), in particular in a reliable and/or rapid manner and/or without use of the detected process data.

Additionally or alternatively, in one embodiment, the testing authority comprises at least one further machine-learned model, wherein, in one embodiment, an assessment by this further machine-learned model is more complex and/or more reliable than with the aid of the model further trained in step (b.2). In one embodiment, process data which for example for a human are (more) difficult to interpret or can only be interpreted with great effort can thus also be used for the labeling.

Additionally or alternatively, in one embodiment the testing authority determines one or more parameters, in one embodiment one or more parameters of the robot or of one or more of the robots with which the particular process is to be or has been performed, and/or one or more parameters of the particular process and/or particular process product, for example a coefficient of friction of a robot gearing or the like, wherein the test assessment is performed in one embodiment on the basis of the one or more determined parameters.

Additionally or alternatively, in one embodiment, the test assessment comprises a test or reference run or trajectory, which is different from the first and, if applicable, second process, of the robot or of the one or more robots by which the particular process is to be or has been performed. In one embodiment, the number of such separate or special test runs can thereby be reduced, and in particular productivity can thus be increased. In one embodiment, the test assessment is performed with the aid of the testing authority on the basis of the data detected during such a test or reference run or trajectory of the robot or one or more of the robots.

In one embodiment, the process data and/or the data used In the test assessment with the aid of the testing authority comprise data, in particular time profiles, of one or more robots with which the process is performed. In one embodiment, these data comprise kinematic data, in particular poses and/or pose changes and/or pose change rates, of the robot(s), in one embodiment axis positions, axis velocities and/or axis accelerations and/or positions and/or orientations of at least one robot-fixed reference such as the TCP or the like, and/or the velocities and/or accelerations thereof, in particular time profiles thereof.

Additionally or alternatively, in one embodiment the process data and/or data used in the test assessment with the aid of the testing authority comprise dynamic data, in particular forces, torques, energies, powers or the like, of the robot(s), in one embodiment driving forces, driving torques, driving energies and/or driving powers, in particular driving voltages and/or driving currents, and/or external forces and/or torques which are determined in one embodiment with the aid of corresponding robot sensors, in particular time profiles thereof.

Such (process) data are particularly suitable for monitoring and very particularly predictive maintenance with the aid of the machine-learned model.

In one embodiment, the process data and/or the data used in the test assessment with the aid of the testing authority comprise data, in one embodiment image data, of one or more process products which is/are handled, in particular transported and/or processed, in the particular process, in particular the particular cycle, in particular handled, in particular transported and/or processed, with the aid of the robot(s).

Additionally or alternatively, in one embodiment, the process data and/or the data used in the test assessment with the aid of the testing authority comprise audio and/or video data, in particular recordings, of the particular process.

Such (process) data are particularly suitable for monitoring errors in the process and/or errors of process products using the machine-learned model.

In one embodiment, the steps (b.1), (b.2) are not (any longer) performed for one or more cycles, even though the model-based assessment performed therein satisfies the examination criterion, if it is detected that a termination criterion, which is predefined in one embodiment and adjustable in a development, is satisfied. The termination criterion can comprise, for example, the reaching of a predefined number of test assessments, which is adjustable in a development, and/or a predefined quality and/or convergence measurement (extent) of the model, which is adjustable in a development, in particular an undershooting of a predefined learning progress which is adjustable in a development.

Thus, in one embodiment, the further training of the model is ended at an advantageous point in time on the basis of deliberately initiated test assessments, thereby (further) increasing the productivity.

In one embodiment, on the basis of the assessment performed in step (a.2), monitoring is performed (already) during the process (run-through) or cycle, the process data of which are to be or have been detected in step (a.1).

In one embodiment, it is thus advantageously possible to use assessments performed in step (a.2) for monitoring purposes in addition to the further training in step (b.2). Additionally or alternatively, in one embodiment, in the current process it is hereby possible to advantageously respond to an implementation of the corresponding monitoring, in one embodiment the assessment by the test assessment or testing authority can be validated or checked and corrected as necessary. This is particularly expedient during the monitoring, in particular predictive maintenance, of at least one robot by which the first or second process is performed.

In one embodiment, the steps (a.1), (a.2) are performed several times, in particular for a plurality of cycles of the robot-assisted first or second process, and subsequently to this multiple performance, in particular after these cycles, the steps (b1.), (b.2) are performed on the basis of the model-based assessments and, if applicable, process data collected during this process or in the cycles, in one embodiment one or more of the collected, in one embodiment stored, model-based assessments and, if applicable, process data is/are collected on the basis of the examination criterion, or, from the collected, in one embodiment stored, model-based assessments and, if applicable, process data, ones for which the assessment satisfies the examination criterion are selected, and for these selected process(run-throughs) or cycles, in one embodiment on the basis of the particular stored process data, (in each case) the test assessment or step (b.1) is performed that is then used for further training of the model in step (b.2).

In one embodiment, the further training in step (b.2) can thereby advantageously be improved and/or the test assessment in step (b.1) can be performed more efficiently. This is particularly expedient when monitoring for errors in the first process and/or process products of the first process,

As already explained, the present invention is particularly suitable for monitoring robots and very particularly the predictive robot maintenance and the process monitoring for errors in the process and/or process products, but without being limited thereto. Accordingly, the monitoring performed in step (c.3) and, if applicable, also the monitoring performed on the basis of the assessment(s) performed in step (a.2), in one embodiment comprises a monitoring, in one development a predictive maintenance, of one or more robots by which the process is performed and/or a monitoring for errors in the process and/or of process products.

In one embodiment, the examination criterion is predefined in such a way that the model-based assessment satisfies the examination criterion if it reveals or outputs or assesses a specific error or a predefined repetition number of the fault, in particular the occurrence of the fault in at least one predefined number of cycles. A specific error can be, in particular, a predefined error type or group of error types, but can also comprise any possible errors. In other words, the examination criterion in one embodiment is predefined in such a way that the model-based assessment satisfies the examination criterion if it assesses or reveals or outputs an error of a predefined error type or group of error types or a predefined repetition number thereof, in another embodiment such that the model-based assessment satisfies the examination criterion if it assesses or reveals or outputs any error or a predefined repetition number thereof. An error within the meaning of the present invention can be, in particular, a current (already present) or a predicted or an imminent error.

In one embodiment, an alarm is output if the model-based assessment satisfies the examination criterion or assesses a specific error. As a result, in one embodiment the safety can be increased.

In a particularly preferred application, a model-based assessment of one or more robots(s) by which the process is performed is thus performed with the aid of a machine-learned model on the basis of process data detected in one embodiment in cycles, and a monitoring, in particular predictive maintenance, of the robot(s), in particular a diagnosis of a state of the robot(s) and/or a prediction of a malfunction, in particular a failure, of the robot(s) is performed on the basis of this assessment.

In one embodiment (for at least one of the cycles), if the model-based assessment outputs or assesses a specific error or a predefined repetition number of the error, a test assessment is performed with the aid of a testing authority, wherein in one embodiment the robot or the robots for this purpose performs/perform a test run, which deviates from the process or cycle, and/or is/are dismantled. In one embodiment, an alarm is output as a result of the assessment or output of the specific error and/or the test assessment is performed in dependence on the external confirmation, in particular only if the external confirmation is also present or is positive. In one embodiment, the machine-learned model is subsequently further trained (step (b.2) on the basis of this test assessment, in particular on the basis of the process data detected in step (a.1) and labeled by the testing authority in step (b.1), and is used subsequently during the further monitoring (steps (c.1)-(c.3)).

As a result, in one embodiment, such (more) complex test assessments are performed or implemented only when required or in the event of a (suspected) error. In this case, it can equally be provided to perform the test assessment for each error assessed by the model-based assessment or even only for certain, for example (more) severe, in particular dangerous, errors, and/or errors which can be reliably identified only by test runs or in the event of disassembly.

In one embodiment, the examination criterion is predefined in such a way that the model-based assessment satisfies the examination criterion with the aid of the model on the basis of detected process data, and the model-based assessment does not satisfy the examination criterion with the aid of the same model on the basis of other detected process data, wherein these process data are referred to as first or second process data without limiting the generality, and wherein an expected gain in information with further training of the model on the basis of the first process data is greater than with further training of the model on the basis of the second process data.

In one embodiment, the information gain to be expected is to be or is determined by means of Uncertainty Sampling, Query-By-Committee, Expected Model Change, Expected Error Reduction, Variance Reduction, Density-Weighted Methods or the like, as described, for example, in Burr Settles: Active Learning Literature Survey, Computer Sciences Technical Report 1648, University of Wisconsin-Madison, 2009 with further evidence, reference being made additionally to this article and the further literature cited therein and the content of which being incorporated fully into the present disclosure. Accordingly, in one embodiment, a model-based assessment can satisfy the examination criterion if its reliability falls below a predefined minimum amount or which, when the model is further trained on the basis of the corresponding process data, the model or its expected error reduction exceeds a predetermined minimum level or the like.

In a particularly preferred application, with the aid of a machine-learned model on the basis of process data detected in cycles, in one embodiment whilst the cycles are being performed or after the cycles have been performed and the detected process data have been stored, a model-based assessment is thus performed of the (product(s) of the) process(es) or cycle/cycles, in one embodiment of the quality or grade, and in one embodiment a monitoring for errors in the process and/or errors of process products is (already) performed on the basis of this assessment, for example process products that are (assessed as) defective are sorted out and/or post-processed and/or process parameters are adapted or the like.

In one embodiment, for at least one of the cycles, if, when the model is further trained on the basis of the process data detected in this cycle, an expected gain in information exceeds a predefined minimum amount and/or is greater than in other cycles, a test assessment is performed with the aid of a testing authority and preferably on the basis of the process data detected in the cycle, wherein in one embodiment the process and/or the process product, in particular an image, in one embodiment an audio and/or video recording, of the process and/or process product is/are for this purpose assessed by the testing authority, in one embodiment a human and/or a further machine-learned model. In one embodiment, the same process data are used for the model-based assessment and the test assessment, for example the further machine-learned model can use the same process data which were used in step (a.2). In another embodiment, different process data are used for the model-based assessment and the test assessment, for example, the further machine-learned model or a human as testing authority may use image, audio, and/or video data, and the machine-learned model further trained in step (b.2) may instead use kinematic and/or dynamic robot data or the like in step (a.2).

In one embodiment, the further training of a machine-learned model can thereby be improved for or during a monitoring, during a cyclical robot-assisted process, for errors in the process and/or process products or the performance achieved.

In one embodiment, before step (c.1), the model is additionally further trained on the basis of detected process data, in a development of the process data detected in at least one of the steps (a.1), without taking into account here, in one embodiment whatsoever, a test assessment with the aid of the testing authority.

Thus, in one embodiment (in step (b.1)), labeled process data and unlabeled process data (from at least one step (a.1)) are used together. In one embodiment, the further training of a machine-learned model or its performance can thereby be improved.

In one embodiment, step (a.1) and/or (c.1) is performed during the particular process (run-through) or cycle, for example data, in particular time profiles, of at least one robot by which the process is performed, and/or audio and/or video data, in particular recordings, of the particular process are detected and optionally stored, or is performed at the end of the cycle or thereafter, for example data, in particular image data, of at least one process product are detected and optionally stored.

In one embodiment, step (a.2), (c.2) and/or (c.3) is performed during the particular process (run-through) or cycle. In particular, a robot monitoring, in particular a predictive maintenance, can thereby respond early to beginning malfunctions.

In one embodiment, step (a.2), (c.2) and/or (c.2) is performed at the end of the particular process (run-through) or cycle or thereafter, in one embodiment (only) after several processes (run-throughs) or cycles. In particular, a training and/or a monitoring for errors in the process and/or of process products can thereby be improved and/or the next cycle can already be started in parallel and the productivity can thereby be improved.

In one embodiment, step (b.1) and/or step (b.2) is performed after the particular process (run-through) or cycle on the basis of the process data of which the test assessment is performed, in a development immediately after the process (run-through) or cycle, in another development after several processes (run-throughs) or cycles. By performance immediately after the cycle, predictive maintenance in particular can respond early to beginning malfunctions, and by performance after several cycles, a training can be improved in particular.

According to one embodiment of the present invention, a system, in particular in terms of hardware and/or software, in particular in terms of programming, is configured to perform a method described herein and/or comprises:
means in order to, for the first or a robot-assisted second process:
(a.1) detect process data; and
(a.2) perform a model-based assessment with the aid of a machine-learned model on the basis of these detected process data;
means in order to, if this performed model-based assessment satisfies an examination criterion, in particular in dependence on an external confirmation:
(b.1) perform a test assessment with the aid of a testing authority, in particular on the basis of these detected process data or independently thereof, in a development on the basis of the process data used in step (a.2), in particular (instead) on the basis of other process data detected in step (a.1) or another part of the process data detected in step (a.1) or on the basis of data not detected in step (a.1), in one embodiment data detected instead during a separate test run or the like; and
(b.2) further train the machine-learned model on the basis of this test assessment;
and means in order to, subsequently for the first process, which is performed again as necessary:
(c.1) detect process data;
(c.2) perform the model-based assessment with the aid of the further-trained model on the basis of these detected process data; and
(c.3) perform a monitoring during the first process on the basis of this assessment.

In one embodiment, the system or its means comprises:
means for performing, during the process for which process data are detected in step (a.1), a monitoring on the basis of the assessment performed in step (a.2); and/or
means for repeatedly performing the steps (a.1), (a.2) and for performing the steps (b1.), (b.2) subsequently to this multiple performance on the basis of the model-based assessments collected here and optionally process data; and/or
means for further training the model before step (c.1), additionally on the basis of detected process data, without a test assessment being taken into account, in particular performed, with the aid of the testing authority.

A means within the meaning of the present invention may be designed in hardware and/or in software, and in particular may comprise a data-connected or signal-connected, in particular, digital, processing unit, in particular microprocessor unit (CPU), graphic card (GPU) having a memory and/or bus system or the like and/or one or a plurality of programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to perform a monitoring during a robot-assisted process. In one embodiment, a computer program product may comprise - and may in particular, be - a particularly non-volatile storage medium for storing a program, or having a program stored thereon, wherein an execution of this program causes a system or a controller, in particular a computer, to carry out the method described herein, or one or multiple steps thereof.

In one embodiment, one or more, in particular all, steps of the method are performed completely or partially automatically, in particular by the system or its means.

In one embodiment, the system comprises the robot.

In one embodiment, the machine-learned model comprises at least one artificial neural network. Such machine-learned models are in particular advantageous for the present invention on the basis of their learning behavior and/or their precision, reliability and/or speed.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically illustrates a system according to one embodiment of the present invention in a cyclic robot-assisted process;

FIG. 2 illustrates a method for monitoring during the cyclic robot assisted process according to an embodiment of the present invention; and

FIG. 3 illustrates a method for monitoring during the cyclic robot-assisted process according to a further embodiment of the present invention.

### DETAILED DESCRIPTION

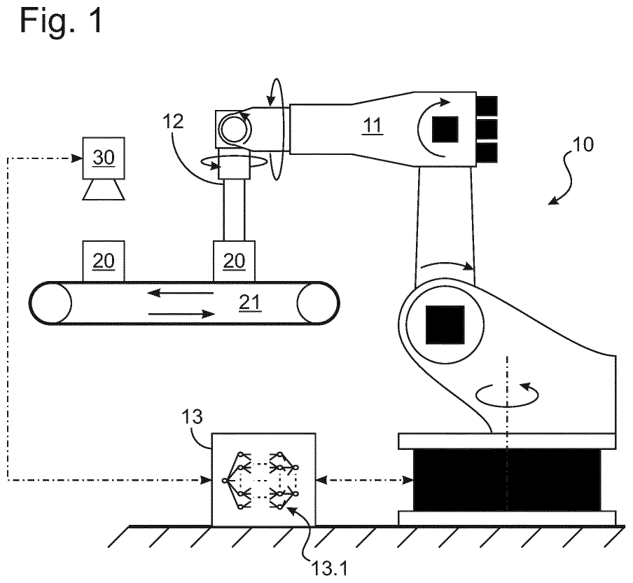

FIG. 1 shows by way of example a robot 10 with a robot arm 11, which in one cycle uses a tool 12 to machine in each case one workpiece 20, which is conveyed to and away or further onwards on a conveyor belt 21 and is recorded by a camera 30 after each processing. A controller of the robot 10 is denoted by 13.

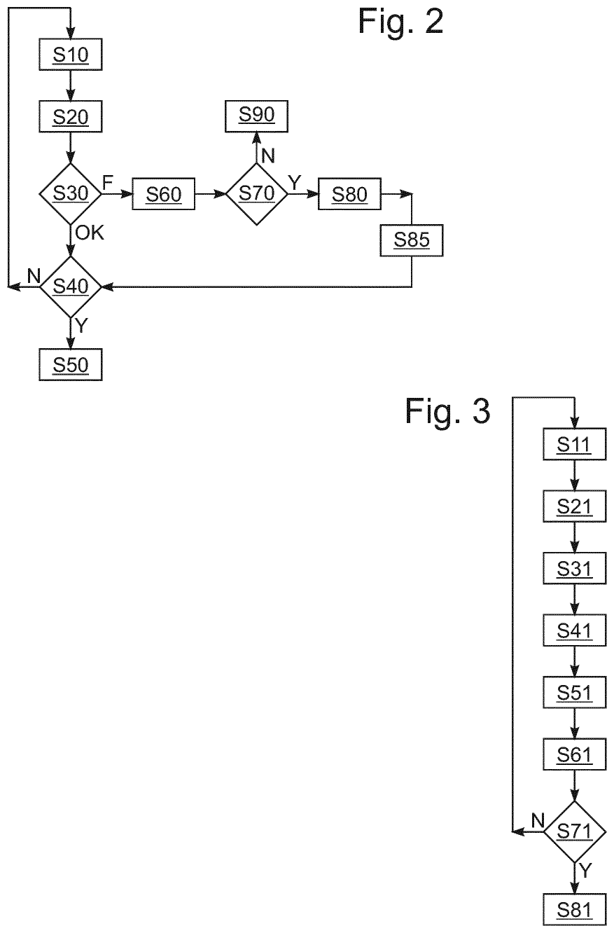

FIG. 2 shows a method for monitoring during the cyclical robot-assisted process according to an embodiment of the present invention.

In a step S10, a cycle of the robot-assisted process sketched with reference to FIG. 1 is performed and process data, in the embodiment by way of example driving forces of the robot 10 or the like, are detected.

With the aid of the model that is machine-learned beforehand by training the artificial neural network 13.1, a model-based assessment of the robot for predictive maintenance is performed on the basis of these detected process data (FIG. 2: step S20), wherein the model or artificial neural network 13.1 in the embodiment, again purely by way of example, on account of the detected driving forces classifies the robot 10 as currently error-free, not in need of maintenance, or as defective or in need of maintenance, i.e. the model-based assessment for monitoring with the aid of the machine-learned model reveals or outputs or assesses an error.

As long as no error is assessed (S30: “OK”) and the intended cycles have not yet all been performed (S40: “N”), the next cycle is performed.

If all the intended cycles have been performed (S40: “Y”), the process is ended (FIG. 2: step S50).

If an error is assessed (S30: “F”), an alarm is output (FIG. 2: step S60).

If an external confirmation is then provided by manual input (S70: “Y”), a test assessment is performed with the aid of a testing authority (FIG. 2: step S80) and the model is further trained on the basis of this test assessment (FIG. 2: step S85).

For this purpose, for example, a reference run is performed with the robot, during which, in the case of defective robots, particularly significant driving forces or the like occur.

On the basis of this reference run or data detected during this run, a testing authority, for example in the form of a different machine-learned model or a signal processing method, performs a test assessment or labels correspondingly the process data detected in step S10 which have led to the error message, it also being possible in one embodiment to distinguish between different errors of the robot.

On the basis of this test assessment, the machine-learned model or artificial neural network 13.1 is further trained and subsequently, if necessary, the next cycle is run through.

Without external confirmation (S70: “N”) a corresponding action is performed in the case of the alarm (S60), for example the robot is repaired (S90).

In a modification, in step S30 the “F” branch is only taken when a predefined error value repetition number has been reached.

It can be seen that the artificial neural network 13.1 is initially triggered on the basis of the process data detected in the normal working process, in particular if the alarm threshold is initially selected to be low as a precaution.

Due to the fact that the correct alarms differ from the false alarms with the aid of the reference runs by the testing authority, and the artificial neural network 13.1 is further trained on the basis of this labeling (step S80), the number of false alarms decreases with increasing duration.

These reference runs are advantageously only performed when this is triggered by the artificial neural network 13.1 or when their assessment signals an error of the robot 10.

FIG. 3 shows a method for monitoring the cyclic robot-assisted process according to a further embodiment of the present invention.

In a step S11, several cycles of the robot-assisted process sketched with reference to FIG. 1 are performed and process data, in this embodiment images of the processed workpieces from the camera 30, are detected.

These are labeled during this process or subsequently by the already (pre-)trained artificial neural network 13.1, which classifies the workpiece in question as “error-free” or “defective” (FIG. 3: step S21). In another embodiment, the artificial neural network 13.1 can additionally or alternatively also use other data, in particular kinematic and/or dynamic robot data.

The image of the processed workpiece from the camera 30 and the associated assessment by the artificial neural network 13.1 (in the other embodiment according to the robot data) are stored in each case (FIG. 3: step S31).

These collected process data and model-based assessments are used in a step S41 to select those cycles in which the reliability of the classification falls below a predefined minimum amount, since further training of the artificial neural network 13.1 with these cycles or images can expect the greatest information gain. In modifications, information gain, entropy or the like can also be used as an examination criterion or can be dependent thereon.

These selected images are labeled by the human (step S51). If, in the above-mentioned modification, the artificial neural network 13.1 uses kinematic and/or dynamic robot data or the like, the model-based assessment and the test assessment are thus performed on the basis of different process data, while the same process data can alternatively also be used.

In a step S61, the artificial neural network 13.1 is further trained with the process data labeled in step S21 and additionally the process data labeled in step S51.

As long as no termination criterion is satisfied, for example the learning progress falls below a predefined minimum level or a predefined repetition number is reached (S71: “N”), the method jumps back to step S11.

If the termination criterion is satisfied (S71: “Y”), the further training is terminated and the artificial neural network 13.1 is used for quality monitoring in the process (step S81).

It can be seen that the artificial neural network 13.1 is thus particularly effectively (further) trained on the basis of the images particularly suitable for this purpose, thereby significantly increasing its performance.

Although embodiments have been explained in the preceding description, it is noted that a large number of modifications are possible.

Thus, in particular, in addition to the labeled process data, unlabeled process data can also be used for the further training of the artificial neural network 13.1.

It is also noted that the embodiments are merely examples that are not intended to restrict the scope of protection, the applications, and the structure in any way. Rather, the preceding description provides a person skilled in the art with guidelines for implementing at least one embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 Robot
11 Robot arm
12 Tool
13 Controller
20 Workpiece
21 Conveyor belt
30 Camera

What is claimed is:

1-11. (canceled)

12. A method for monitoring during a robot-assisted first process, wherein the following steps are performed by a robot controller for at least the robot-assisted first process:
(a.1) detecting process data;
(a.2) performing a first model-based assessment with the aid of a machine-learned model on the basis of the detected process data;
in response to the model-based assessment satisfying an examination criterion, then:
(b.1) performing a test assessment with the aid of a testing authority, and
(b.2) further training the machine-learned model on the basis of the test assessment;
(c.1) detecting further process data for the first process;
(c.2) performing a second model-based assessment with the aid of the further trained machine-learned model on the basis of the further detected process data; and
(c.3) monitoring the robot during the first process and based on the second model-based assessment.

13. The method of claim 12, wherein the examination criterion depends on an external confirmation.

14. The method of claim 12, wherein at least one of:
the testing authority comprises at least one person;
the testing authority comprises at least one further machine-learned model;
the testing authority determines at least one parameter; or
the test assessment comprises a test run of at least one robot by which the particular process is performed, the test run being different than the first process.

15. The method of claim 14, wherein the test run is different than a second process.

16. The method of claim 12, wherein at least one of the process data or data used in the test assessment are at least one of:
data of at least one robot by which the particular process is performed;
data of at least one process product of the particular process; or
at least one of audio or video data of the particular process.

17. The method of claim 16, wherein at least one of:
the data of at least one robot by which the particular process is performed are time profiles; or
the data of at least one process product of the particular process are image data.

18. The method of claim 12, further comprising:
monitoring the robot during the first process and based on the first model-based assessment.

19. The method of claim 12, wherein:
steps (a.1) and (a.2) are performed at least two times; and then
steps (b.1) and (b.2) are performed.

20. The method of claim 12, wherein monitoring comprises at least one of:
monitoring at least one robot by which the first process is performed;
predictive maintenance monitoring of at least one robot by which the first process is performed;
monitoring for errors in the first process; or
monitoring for errors in process products of the first process.

21. The method of claim 12, wherein the examination criterion is predefined in such a way that the model-based assessment satisfies the examination criterion when the model-based assessment reveals a specific error or a predefined repetition number of the error.

22. The method of claim 12, wherein:
the examination criterion is predefined in such a way that:
the model-based assessment satisfies the examination criterion with the aid of the model on the basis of the first detected process data, and
the model-based assessment does not satisfy the examination criterion with the aid of the same model on the basis of second detected process data; and
an expected gain in information during further training of the model on the basis of the first process data is greater than during further training of the model on the basis of the second process data.

23. The method of claim 12, wherein the model is further trained before step (c.1) additionally on the basis of detected process data without a test assessment being taken into account.

24. The method of claim 23, wherein the model is further trained with the aid of the testing authority.

25. a system for monitoring during a robot-assisted first process, the system comprising:
for the robot-assisted first process or a robot-assisted second process, means for:
(a.1) detecting process data, and
(a.2) performing a model-based assessment with the aid of a machine-learned model on the basis of the detected process data; and
means configured to, in response to the model-based assessment satisfying an examination criterion:
(b.1) perform a test assessment with the aid of a testing authority, and
(b.2) further train the machine-learned model on the basis of the test assessment.

26. The system of claim 25, wherein the system further comprises means for:
(c.1) detecting further process data for the first process;
(c.2) performing a second model-based assessment with the aid of the further trained model on the basis of the further detected process data; and
(c.3) monitoring the robot during the first process and based on the second model-based assessment.

27. The method of claim 25, wherein the examination criterion depends on an external confirmation.

28. A computer program product for monitoring during a robot-assisted first process, the computer program product comprising program code stored on a non-transitory, computer-readable medium, the program code configured, when executed by a computer, to cause the computer to perform for the robot-assisted first process, the method set forth in claim 12.
